(19) United States
(12) Patent Application Publication
(10) Pub. No.: US 2023/0380427 A1
(43) Pub. Date: Nov. 30, 2023

(54) USE OF MICROORGANISMS AND CALCIUM FOR IMPROVED PLANT HELATH AND/OR RESILIENCE AGAINST PLANT PATHOGENS

(71) Applicants: Universität für Bodenkultur Wien, Wien (AT); Valibiotics GmbH, Traiskirchen (AT)

(72) Inventors: Wolfgang HARREITHER, Traiskirchen (AT); Marc LEMMENS, Wien (AT); Reza OMIDVAR, Wien (AT)

(73) Assignees: Universität für Bodenkultur Wien, Wien (AT); Valibiotics GmbH, Traiskirchen (AT)

(21) Appl. No.: 18/031,793

(22) PCT Filed: Oct. 15, 2021
(86) PCT No.: PCT/EP2021/078650

§ 371 Date: Apr. 13, 2023

(30) Foreign Application Priority Data
Oct. 16, 2020 (EP) 20202265.3

(51) Int. Cl. A01N 63/20; A01N 63/32; A01N 59/08; A01P 21/00; A01P 3/00

(52) U.S. Cl. CPC A01N 63/20; A01N 63/32; A01N 59/08; A01P 21/00; A01P 3/00; C12R 2001/25

(57) ABSTRACT

The present invention relates in general to the use of a kit or composition comprising at least one yeast and at least one bacterium, selected from the group consisting of lactobacillales, rhizobiales and bifidobacteriales, and/or comprising calcium for improving plant health, for improving plant resistance to plant pathogens, for preventing or reducing mycotoxin contamination of plant material, for improving plant resistance to a plant disease, for preventing perithecia formation of a plant pathogen on plant debris, for plant protection and/or as plant stimulant. The present invention also relates to corresponding compositions and kits and a method of applying such composition or kit to a living plant or plant debris.

The present invention relates to the use of a kit or composition comprising at least one yeast and at least one bacterium, selected from the group consisting of lactobacillales, rhizobiales and bifidobacteriales, and/or comprising calcium for improving plant health, for improving plant resistance to plant pathogens, for preventing or reducing mycotoxin contamination of plant material, for improving plant resistance to a plant disease, for preventing perithecia formation of a plant pathogen on plant debris, for plant protection and/or as plant stimulant. The present invention also relates to corresponding compositions and kits and a method of applying such composition or kit to a living plant or plant debris.

Agronomically relevant crops such as cereals (wheat, durum, barley, rye, triticale), maize, vegetables or fruit are threatened by infection with various harmful pathogens, e.g. fungi. The resulting diseases cause crop failures or loss of quality and thus lead to heavy losses along the entire production chain from seed to stored harvests.

Fusarium head blight (FHB) in cereals (Fusarium graminearum) and Fusarium ear rot (FER) in maize, are known as two of the major problems in agriculture. FHB and FER cause quality losses due to contamination of the kernels with mycotoxins that pose a significant threat to the health of domestic animals and humans, and for which food regulations are set all over the world. Fusarium species cause economic losses worldwide in a magnitude of several billion Euros annually. Indirect costs, e.g. through mycotoxin monitoring programs and reduction of livestock performance is estimated to be even higher. Fusarium graminearum can only survive on infested crop residues which remain in the field after the harvest. In spring, when the weather conditions are favorable, the sexual stage of the fungus (Gibberella zeae) develops on the infested crop debris. Fruiting bodies of the fungus (perithecia) are formed on the surface of these residues and the sexual spores (ascospores) which are the primary inoculum for infection in the new season are discharged into the air. Appropriate crop rotation can help to reduce spore production, but in many regions a close crop rotation between maize and cereals is practiced (wheat after maize, corn after corn and wheat after wheat) and since the same Fusarium pathogen affects both crops, the disease pressure increases year by year.

Among the most important fungal diseases in viticulture are esca (caused by the fungi Fomitiporia, Phaeomoniella and Phaeoacremonium), downy mildew (caused by Plasmopara viticola), powdery mildew (Erysiphe necator) as well as the grey mould (Botrytis cinerea). These diseases lead to enormous yield losses, up to entire crop failures and even death of the vines in the entire vineyard.

Potato late blight, caused by the oomycete Phytophthora infestans, is the most devastating and difficult to control disease in potato production, which can lead to complete yield loss.

In sugar beets, foliar diseases caused by pathogenic fungi such as Cercospora beticola (Cercospora leaf spot), Ramularia betae (Ramularia leaf spot), Uromyces betae (Rust), Erysiphe betae (powdery mildew) represent a major problem and lead to enormous yield and quality losses, up to entire crop failures.

The most important fungal pathogens for apples are Venturia inaequalis (apple scab) as well as the causative fungi for powdery mildew, Podosphaera leucotricha. These diseases can lead to deformation, dwarfism and eventually lead to loss of yield and quality.

In onions Fusarium oxysporum is a well-known soil-borne pathogen leading to basal root rot and hence damage the whole plant.

In oilseed rape, Sclerotinia stem rot is caused by the phytopathogenic fungus Sclerotinia sclerotiorum and causes major problems due to perturbed seed development and hence decreased yield.

In sunflower, Sclerotinia sclerotiorum is the causal pathogen for head and stalk rot as well as root wilt. If infected early or root infection occurs, plants typically die off quickly. Head rot of wilted plants are generally smaller and seed weights are lower compared to healthy plants.

Typically, synthetic pesticides are used in an attempt to prevent the outbreak, or at least to confine the spread of fungal infections. However, the fungicides widely used in today's agriculture, do not always show the required efficacy because resistance to these chemicals has been increased and at the same time the chemical synthetic fungicides causes stress in treated plants and also have negative effects on soil and environment. Moreover, organic farming does not allow at all the use of chemical synthetic fungicides.

Xue et al. (Can. J. Plant Pathol. 31: 169-179) discloses the control of Fusarium head blight by using the microorganism Clonostachys rosea.

US 2019/0133136 A1 discloses the use of microorganism selected from the group consisting of Pseudomonas trivialis, Pseudomonas lurida, Phaeophlebiopsis sp., Periconia macrospinosa and combinations thereof for the treatment of Fusarium head blight.

WO 2013/174792 discloses the use of specific Lactobacillae (Lactobacillus paracasei, Lactobacillus plantarum) for controlling of growth of a contaminant, such as a bacteria, yeast or mould on food or feed.

Irrespective of the existing strategies to prevent spread of pathogen contamination, there is still a great need in the art for novel means to prevent losses in plant production due to infestation with pathogens, in particular infestation with fungi. It was therefore an object of the present invention to provide such new means, in particular means for improving plant health, for improving plant resistance to plant pathogens, and for preventing or reducing mycotoxin contamination of plant material.

This problem is solved by the subject-matter as set forth below and in the appended claims.

The inventors of the present invention have surprisingly found that specific microorganisms, calcium and combinations of both can effectively be used to strengthen the resistance of plants to plant pathogens, in particular to strengthen resistance to plant pathogenic fungi.

Therefore, the present invention relates in a first aspect to the use of a composition or a kit comprising:
a) at least two, preferably at least three, more preferably at least four, even more preferably at least five different microorganisms, most preferably six different microorganisms, wherein the microorganisms are selected from bacteria and yeast, wherein microorganisms comprise at least one bacterium and one yeast, and wherein the bacteria are selected from the group consisting of lactobacillales, rhizobiales and bifidobacteriales; and/or
b) calcium, preferably wherein the calcium is present in form of calcium chloride, calcium propionate, or calcium lactate, calcium acetate, calcium citrate and calcium carbonate in particular calcium chloride, calcium propionate or calcium carbonate.

for improving plant health, improving plant resistance to plant pathogens, preventing or reducing mycotoxin contamination of plant material, improving plant resistance to a plant disease (e.g. caused by a plant pathogen), for preventing perithecia formation of a plant pathogen on plant debris, for plant protection and/or as plant stimulant.

As used herein, “improving plant health” is understood as encompassing any form of improvement in plant health, in particular in terms of reduced disease incidence in treated plants with the composition or kit in comparison with non-treated plants grown under the same conditions.

“Improving plant resistance to plant pathogens”, as used herein, refers to an increased capacity of a given plant in resistance against at least one plant pathogen, in particular a fungus such as F. graminearum. Increased resistance may for example manifest in form of a reduction in occurrence of pathogen infestation, reduction in disease symptoms caused by the pathogen and/or reduced recovery time from the disease caused by the pathogen. Improved resistance to the target pathogen could be observed by comparison of plants treated with the composition or kit of the invention with untreated plants grown under the same experimental conditions.

“Improving plant resistance to a plant disease caused by a plant pathogen”, as used herein, refers to a reduced incidence or severity of a plant disease in plants treated with the composition or kit in comparison to untreated plants grown under the same conditions. Infectious plant diseases are caused by a pathogenic organism such as a fungus or bacterium.

The term “comprising”, as used herein, shall not be construed as being limited to the meaning “consisting of” (i.e. excluding the presence of additional other matter). Rather, “comprising” implies that optionally additional matter, features or steps may be present. The term “comprising” encompasses as particularly envisioned embodiments falling within its scope “consisting of” (i.e. excluding the presence of additional other matter) and “comprising but not consisting of” (i.e. requiring the presence of additional other matter, features or steps), with the former being more preferred.

The use of the word “a” or “an”, when used herein, may mean “one,” but it is also consistent with the meaning of “one or more,” “at least one,” and “one or more than one.”

Within the context of the first aspect of the invention (the inventive use), but also in the context of the method of the present invention, the plant may be any type of plant which benefits from treatment with the aforementioned composition (or kit). Preferably, the plant is an agricultural crop. Particularly preferred plants are plants selected from the group of small grain cereals, maize and grapevine, for which the inventors have already demonstrated in the examples very effective treatment with the aforementioned composition (or kit) comprising microorganisms and/or calcium. The inventors envision in particular application of the aforementioned composition (or kit) on plants (and plant material of corresponding plants etc.) selected from the group consisting of wheat, barley, oat, rye, triticale, maize, grapevine, potato, sugar beet, onion, apple, oilseed rape or sunflower, in particular wheat, maize, grapevine, potato, sugar beet, onion, apple, oilseed rape or sunflower. Most preferably the plants are selected from wheat and grapevine. The plant may benefit from being directly treated with the composition (or kit), leading to improved health and resistance to disease pressure from plant pathogens, in particular fungi such as Fusarium graminearum or other plant pathogenic fungi. However, as shown also in the examples, the plant may also benefit indirectly from application of the composition (or kit) comprising microorganisms and/or calcium by applying the composition (or kit) on plant debris and dead plant material from the last growing season, on which hemibiotrophic/necrotrophic pathogens such as F. graminearum can survive during the winter and start a new infection cycle in the spring.

The microorganisms to be used according to the first aspect of the invention are at least two, namely at least one bacterium and at least one yeast. Preferably, the composition (or kit) comprises more than two microorganisms, such as at least three, at least four or at least five microorganisms, with the latter being most preferred. The composition or kit may for example comprise 2 to 6 microorganisms, 3 to 6 microorganisms, 4 to 6 microorganisms or exactly 6 microorganisms. The selected microorganisms can be freely chosen from bacteria and yeast, but preferably the composition or kit comprises more bacteria than yeast.

As mentioned previously, the bacteria are selected from the group consisting of lactobacillales, rhizobiales and bifidobacteriales. Preferably, the composition (or kit) to be used according to the first aspect of the invention comprises predominantly or even exclusively lactobacillales, such as L. fermentum, L. casei, or L. plantarum. Most preferably, the composition (or kit) comprises as bacterium at least one L. plantarum strain. According to the invention (i.e. irrespective of the aspect of the invention), a particularly preferred subspecies of L. plantarum is Lactiplantibacillus plantarum subsp. plantarum. If the composition (or kit) comprises at least one bacterium selected from rhizobiales, then preferably the bacterium is R. palustris. In case the composition (or kit) comprises at least one bacterium selected from bifidobacteriales, then preferably the bacterium is selected from the group consisting of Bifidobacterium bifidum, and B. animalis. In a particularly preferred embodiment of the invention, all bacteria of the composition (or kit) are selected from the group consisting of L. fermentum, L. casei, L. plantarum, R. palustris; Bifidobacterium bifidum, and B. animalis. The at least one yeast in the composition (or kit) of the inventive use (i.e. the first aspect of the invention) is preferably S. cerevisiae. Most preferably, the at least two, at least three, at least four or at least five microorganisms of the composition (or kit) are selected from the group consisting of L. fermentum, L. casei, L. plantarum, S. cerevisiae, R. palustris, B. bifidum, and B. animalis, even more preferably from the group consisting of L. fermentum, L. casei, L. plantarum, and S. cerevisiae.

The different microorganisms may differ only on strain level, i.e. need not be different species. For example, a composition (or kit) comprising at least three different microorganisms may comprise at least one bacterium and two different strains of the same yeast, e.g. two different types of S. cerevisiae. Likewise, the composition may comprise at least one yeast and two different strains of the same bacterium, e.g. two different strains of L. fermentum, L. casei, or L. plantarum, in particular of L. plantarum. Preferably, the composition (or kit) to be used according to the first aspect of the invention comprises more than one lactobacillus strain. In some embodiments, the composition (or kit) will comprise at least two strains of the same bacteria, e.g. two lactobacillus strains of the same species, and in parallel two different strains of the same yeast, e.g. two S. cerevisiae strains. Particularly preferred combinations of bacteria in the composition (or kit) to be used are i) L. fermentum, L. casei, L. plantarum, and R. palustris, ii) L fermentum, L. casei, L. plantarum, R. palustris, B. bifidum, and B. animalis, and iii) L. fermentum, L. casei, and two different kinds of L. plantarum strains, with the latter being the most preferred embodiment. As mentioned above, a particularly preferred subspecies of L. plantarum is Lactiplantibacillus plantarum subsp. plantarum.

Compositions exemplified in the example sections (and corresponding kits) are particularly preferred compositions (and kits) to be used in the context of the first aspect of the invention and may comprise:
i) L. fermentum, L. casei, L. plantarum (e.g. L. plantarum subsp. plantarum), S. cerevisiae, R. palustris;
ii) L. fermentum, L. casei, L. plantarum (e.g. L. plantarum subsp. plantarum), S. cerevisiae, R. palustris, B. bifidum, B. animalis; or (most preferably)
iii) L. fermentum, L. casei, two different L. plantarum strains (e.g. of subspecies L. plantarum subsp. plantarum) and two different S. cerevisiae.

The microorganisms required for the use of the first aspect of the invention are readily available to the skilled person and are for example commercially available from depositories of microorganisms such as the American Type Culture Collection (ATCC, USA), the Czech Collection of Microorganisms (CCM), the German Collection of Microorganisms and Cell Cultures (DSMZ, Germany), Netherlands Culture Collection of Bacteria &CBS (NCCB/CBS), Biological Resource Center, National Institute of Technology and Evaluation (IFO, Japan) or the Korean Culture Center of Microorganisms (KCCM).

Instead of the microorganisms, or in combination with the microorganisms, the composition (or kit) to be used according to the first aspect of the invention may also comprise calcium, i.e. in form of calcium ions. As demonstrated by the inventors, calcium does also provide for a positive effect on plant health and may be used (alone or in combination with the microorganisms) for improving plant health, for improving plant resistance to plant pathogens, for preventing or reducing mycotoxin contamination of plant material, for improving plant resistance to a plant disease (e.g. caused by a plant pathogen), for preventing perithecia formation of a plant pathogen on plant debris, for plant protection and/or as plant stimulant.

The calcium can be provided for example in form of calcium chloride, calcium propionate, calcium lactate, calcium acetate, calcium citrate, calcium carbonate, or mixtures thereof etc.

Most preferably it is provided as calcium chloride. In particular, the calcium should be present in water soluble form in the composition (or kit) to allow easy distribution and/or uptake by the plant or plant material. The calcium should preferably not be provided as calcium carbonate, in particular due to the weak solubility. If a relatively insoluble form of calcium such as calcium carbonate is used, then it is advisable to use for example in parallel an acid, in particular organic acids such as lactic acid, propionic acid, acetic acid or citric acid to facilitate formation of soluble calcium compounds. Inventive compositions may comprise for example the following concentrations of calcium: about 5 mM to about 250 mM, more preferably about 15 mM to about 100 mM, more preferably about 20 mM to about 70 mM and most preferably about 30 mM. For example, in those embodiments where calcium is provided in the form of calcium chloride, the composition (or kit) may comprise about 0.3% to 5% (w/v), 0.6%-3% (w/v), 0.6 to 1.8% (w/v), 0.3 to 0.6% (w/v) or for example 0.9% (w/v) calcium chloride. The most preferred concentration range may vary slightly with the plant to be treated. For example, if wheat is to be treated, the range for calcium chloride is preferably 0.6% to 1.2% (w/v), most preferably 0.9% (w/v). If grapevine is to be treated, the concentration of calcium chloride is preferably in the range of 0.3 to 0.6% (w/v). In some embodiments, and in particular in the case of grapevine treatment, the inventive composition may also be applied more than once per field season. For example, it can be applied at least 3 times per field season.

According to the first aspect of the invention, the composition (or kit) comprising the microorganisms and/or calcium may be used for improving plant health, improving plant resistance to plant pathogens, preventing or reducing mycotoxin contamination of plant material, improving plant resistance to a plant disease (e.g. caused by a plant pathogen), for preventing perithecia formation of a plant pathogen on plant debris, for plant protection and/or as plant stimulant. In cases where the composition (or kit) is used for improving plant resistance to a plant pathogen, improving plant resistance to a plant disease caused by a plant pathogen, or for preventing perithecia formation of a plant pathogen on plant debris, has been mentioned that the target plant pathogen may be for example a fungus. Preferably, the plant pathogen is not purely biotrophic, but hemibiotrophic or necrotrophic, preferably hemibiotrophic. The plant pathogen may for example be a pathogen for any of the above-mentioned agricultural crops, in particular for small grain cereals, maize, and grapevine. Examples of pathogens which are specifically considered by the inventors of the present invention are Fusarium graminearum, Plasmopara viticola, Erysiphe necator, Phytophthora infestans, Cercospora beticola, Ramularia betae, Venturia inaequalis, Podosphaera leucotricha, Fusarium oxysporum and Sclerotinia sclerotiorum. Most preferably, the plant pathogen is Fusarium graminearum and Plasmopara viticola.

According to the first aspect of the invention, the composition (or kit) comprising microorganisms and/or calcium may also be used for improving plant resistance to a plant disease caused by a plant pathogen. The skilled person will be readily familiar with the plant diseases and plant pathogens of the individual plants, in particular for agricultural crops. For example, the plant disease may be Fusarium head blight or Fusarium ear rot, both caused by F. graminearum. In addition, the inventors also contemplate application of the composition (or kit) comprising microorganisms and/or calcium as defined above for improving plant resistance to downy mildew (Plasmopara viticola) or powdery mildew (Erysiphe necator), According to the present invention, improvement of resistance of wheat or maize against Fusarium head blight or Fusarium ear rot (caused by F. graminearum) is particularly preferred.

Preferably, the composition (or kit) to be used according to the first aspect of the invention does not comprise phototrophic bacteria, because such bacteria are not essential for attaining the desired effect (i.e. for improving plant health, improving plant resistance to plant pathogens, preventing or reducing mycotoxin contamination of plant material, for improving plant resistance to a plant disease (e.g. caused by a plant pathogen), or for preventing perithecia formation of a plant pathogen on plant debris). However, presence of such kind of bacteria is of course also not precluded when carrying out the teaching of the present invention.

The composition (or kit) to be used according to the first aspect of the invention may allow any desired application of the composition (or kit) on the plant, plant material or plant debris of interest. It may be for example a liquid or a powder. Preferably, the composition is a liquid (or the respective components of the kit are present in liquid form). Such liquid composition and components may be conveniently sprayed on the plant (plant material, plant debris), allowing even distribution of the composition (or kit components). However, and in particular for storage purposes, also dried compositions (or kit components) are conceivable and encompassed by the scope of the first aspect of the invention. Dried compositions or kit compositions may for example include lyophilized microorganisms.

In a second aspect, the present invention relates to a composition comprising at least two, preferably at least three, more preferably at least four and most preferably at least five microorganisms and optionally calcium, wherein at least one of the microorganisms is a bacterium and at least one is a yeast (preferably S. cerevisiae), and wherein the bacteria are Lactobacillales, and wherein the composition does preferably not comprise R. palustris. The inventive composition according to the second aspect of the invention may optionally additionally comprise other bacteria, such as bifidobacteriales, in particular B. bifidum, and B. animalis. However, compositions without bifidobacteriales, e.g. without B. bifidum, and B. animalis, are also specifically contemplated by the inventor. A particularly preferred composition of the present invention will neither comprise R. palustris nor B. bifidum, nor B. animalis. Otherwise, the microorganisms of the inventive composition may be the same as defined above for the inventive use according to the first aspect of the invention. As before, the microorganisms of the inventive composition according to the second aspect of the invention are at least two, namely at least one bacterium and at least one yeast. Preferably, the inventive composition comprises more than two microorganisms, such as at least three, at least four or at least five microorganisms, with the latter being most preferred. The composition may for example comprise 2 to 5 microorganisms, 3 to 5 microorganisms, 4 to 5 microorganisms or exactly 5 microorganisms. The selected microorganisms can be freely chosen from bacteria (preferably with the exception of R. palustris) and yeast, but preferably the composition comprises more bacteria than yeast. The inventive composition of the second aspect of the invention may comprise predominantly or even exclusively lactobacillales, such as L. fermentum, L. casei, or L. plantarum. Most preferably, the inventive composition according to the second aspect comprises as bacterium at least one L. plantarum strain (preferably of subspecies L. plantarum subsp. plantarum). In case the inventive composition is to comprise at least one bacterium selected from bifidobacteriales, then preferably the bacterium is selected from the group consisting of Bifidobacterium bifidum, and B. animalis. In a particularly preferred embodiment of the invention, all bacteria of the inventive composition are selected from the group consisting of L. fermentum, L. casei, L. plantarum, Bifidobacterium bifidum, and B. animalis. The at least one yeast in the inventive composition of the second aspect of the invention is preferably S. cerevisiae. More preferably, the at least two, at least three, at least four or at least five microorganisms of the composition are selected from the group consisting of L. fermentum, L. casei, L. plantarum, S. cerevisiae, B. bifidum, and B. animalis. Most preferably, the at least two, at least three, at least four or at least five microorganisms of the composition are selected from the group consisting of L fermentum, L. casei, L. plantarum, and S. cerevisiae.

The different microorganisms of the inventive composition of the second aspect of the invention may differ only on strain level, i.e. need not be from different species. For example, an inventive composition comprising at least three different microorganisms may comprise at least one bacterium and two different strains of the same yeast, e.g. two different types of S. cerevisiae. Likewise, the composition may comprise at least one yeast and two different strains of the same bacterium, e.g. two different strains of L. fermentum, L. casei, or L. plantarum, in particular of L. plantarum (preferably of subspecies L. plantarum subsp. plantarum). Preferably, the inventive composition of the second aspect of the invention comprises more than one lactobacillus strain. In some embodiments, the composition will comprise at least two strains of the same bacteria, e.g. two lactobacillus strains of the same species, and in parallel two different strains of the same yeast, e.g. two S. cerevisiae strains. A particularly preferred combination of bacteria in the inventive composition of the second aspect is L. fermentum, L. casei, and two different kinds of L. plantarum strains (preferably of subspecies L. plantarum subsp. plantarum).

A composition of the second aspect of the invention and exemplified in the example section is a composition comprising L. fermentum, L. casei, two different L. plantarum strains (preferably of subspecies L. plantarum subsp. plantarum) and S. cerevisiae. As before for the inventive use according to the first aspect of the invention, the microorganisms required for the composition of the second aspect of the invention are readily available to the skilled person.

In a third aspect, the present invention relates to a composition comprising at least the following bacteria: L. fermentum, L. casei, two different kinds of L. plantarum strains, and at least two S. cerevisiae strains. Such composition may comprise also additional bacteria, for example bacteria selected from the group consisting of lactobacillales, rhizobiales and bifidobacteriales. Preferably, the composition according to the third aspect of the invention comprises predominantly or even exclusively lactobacillales, such as L. fermentum, L. casei, or L. plantarum (preferably of subspecies L. plantarum subsp. plantarum). If the composition comprises at least one bacterium selected from rhizobiales, then preferably the bacterium is R. palustris. In case the composition is to comprises at least one bacterium selected from bifidobacteriales, then preferably the bacterium is selected from the group consisting of B. bifidum, and B. animalis.

The compositions of the second and third aspect of the invention may also comprise calcium, i.e. in form of calcium ions. The calcium may be present for example in form of calcium chloride, calcium propionate, calcium lactate, calcium acetate, calcium citrate, calcium carbonate, or mixtures thereof etc. Most preferably it is provided as calcium chloride, calcium carbonate or calcium propionate. In particular, and as already outlined previously for the inventive use, the calcium should be present in water soluble form in the compositions of the second or third aspect of the invention to allow easy distribution and/or uptake of the compositions by the plant or plant material. The calcium should ideally not be provided as calcium carbonate, in particular due to the weak solubility. If a relatively insoluble form of calcium such as calcium carbonate or calcium sulfate is used, then it is advisable if the inventive compositions comprise in parallel an acid, in particular organic acids such as lactic acid to facilitate formation of soluble calcium compounds. Inventive compositions may comprise for example the following concentrations of calcium: about 5 mM to about 250 mM, about 15 mM to about 100 mM, about 20 mM to about 70 mM and about 30 mM. For example, in those embodiments where calcium is provided in the form of calcium chloride, the composition (or kit) may comprise about 0.3% to 5%, 0.6%-3%, 0.6 to 1.8%, 0.3 to 0.6% or for example 0.9%. calcium chloride. The most preferred concentration range may vary with the plant to be treated. For example, if wheat is to be treated, the range for calcium chloride is preferably 0.6% to 1.2%, most preferably 0.9% (always as (w/v)). If grapevine is to be treated, the concentration of calcium chloride is preferably in the range of 0.3 to 0.6% (w/v).

Preferably, the inventive compositions of the second or third aspect do not comprise phototrophic bacteria, because such bacteria are not essential for attaining the desired effect of the invention (i.e. for improving plant health, improving plant resistance to plant pathogens, preventing or reducing mycotoxin contamination of plant material, improving plant resistance to a plant disease (e.g. caused by a plant pathogen), or for preventing perithecia formation of a plant pathogen on plant debris). However, presence of such kind of bacteria is of course also not precluded when carrying out the teaching of the second and third aspect of the invention.

As before for the inventive use according to the first aspect of the invention, the compositions of the second and third aspect of the invention may take any desired form allowing application of the inventive composition to a plant. The compositions may be for example a liquid or a powder. Preferably, the inventive compositions are a liquid so as to allow even distribution of the composition on plant or plant material. However, and in particular for storage purposes, also dried compositions are conceivable and encompassed by the scope of the second and third aspect of the invention.

The compositions of the second and third aspect of the invention can be used when carrying out the inventive use, i.e. the first aspect of the invention (see above) or for the inventive method (see below).

In a fourth aspect, the present invention relates to a kit (kit of parts) comprising at least two, preferably at least three, more preferably at least four, even more preferably at least five different microorganisms, most preferably even six microorganisms and optionally calcium, wherein at least one of the microorganisms is a bacterium and at least one is a yeast, and wherein the bacteria are lactobacillales, and wherein the kit does preferably not comprise R. palustris. The inventive kit according to the fourth aspect of the invention may optionally additionally comprise other bacteria, such as bifidobacteriales, in particular B. bifidum, and B. animalis. However, compositions without bifidobacteriales, e.g. without B. bifidum, and B. animalis, are also specifically contemplated by the inventors. A particularly preferred composition of the present invention will neither comprise R. palustris nor B. bifidum, nor B. animalis. Otherwise, the microorganisms of the inventive kit may be the same as defined above for the inventive compositions according to the second and third aspect of the invention. The microorganisms may be contained in individual containers or some or all of them may be contained in the same container. The inventive kit may further comprise calcium, and what has been set out above for the inventive compositions equally applies to the inventive kit. The calcium is preferably provided in a separate container but may also be comprised in the same container as one or more of the microorganisms. The microorganisms may be present in the kit in dry (e.g. lyophilized) or liquid form. Particularly preferred kits according to the present invention are kits which do not comprise R. palustris and kits which comprise L. fermentum, L. casei, and two different kinds of L. plantarum strains, in particular which comprise L. fermentum, L. casei, two different kinds of L. plantarum strains and two different kinds of S. cerevisiae. An inventive kit according to the present invention can for example be used to create a composition according to the second or third aspect of the invention and can also be used to carry out the inventive use according to the first aspect of the invention. In embodiments where the kit comprises L. plantarum, it preferably comprises L. plantarum subsp. plantarum.

In a fifth aspect, the present invention relates to a method comprising the step of applying a composition or kit comprising:
a) at least two, preferably at least three, more preferably at least four, even more preferably at least five different microorganisms, wherein the microorganisms are selected from bacteria and yeast, wherein at least one of the microorganisms is a bacterium and at least one is a yeast (preferably S. cerevisiae), and wherein the bacteria are selected from the group consisting of lactobacillales, rhizobiales and bifidobacteriales and/or
b) calcium, wherein the calcium is present in form of calcium chloride, calcium carbonate, calcium acetate, calcium citrate, calcium propionate, or calcium lactate, in particular calcium chloride, calcium carbonate or calcium propionate.
to a living plant and/or plant debris.

In the context of the inventive method according to the fifth aspect of the invention, the composition may be a composition as defined in the context of the first aspect of the invention or a composition according to the second or the third aspect of the invention. The kit may for example be a kit according to the fourth aspect of the invention. The plant (and corresponding plant debris) may be again (i.e. like for the first aspect of the invention) any type of plant which benefits from treatment with the inventive method. Preferably, the plant is an agricultural crop. Particularly preferred plants are plants selected from the group of small grain cereals, maize and grapevine. The inventors envision in particular application of the aforementioned method to plants (and plant material of corresponding plants etc.) selected from the group consisting of wheat, barley, oat, rye, triticale, maize, grapevine, potato, sugar beet, onion, apple, oilseed rape or sunflower, in particular wheat, maize, grapevine, potato, sugar beet, onion, apple, oilseed rape and sunflower. Most preferably the plants are selected from wheat and grapevine.

The method according to the present invention may for example be a method for improving plant health, a method for improving plant resistance to plant pathogens, a method for preventing or reducing mycotoxin contamination of plant material, a method for improving plant resistance to a plant disease (e.g. caused by a plant pathogen), and/or a method for preventing perithecia formation of a plant pathogen on plant debris.

The method of the present invention may involve application of a composition (or kit) comprising microorganisms as defined above to the plant or plant debris of interest as well as application of a composition comprising calcium as defined above on the plant or plant debris of interest. The method may also involve application of both, i.e. microorganisms and calcium, to the plant of interest, wherein the application to the plant of interest can occur in parallel (for example by being contained in the same composition or by being applied in parallel but from different containers). In the alternative, the composition or kit may be applied on the plant of interest or plant debris in sequential manner, beginning for example with one, more than one or all of the microorganisms and subsequent application of calcium (with the opposite sequence being of course also possible).

Preferably, the composition or the components of the kit are applied in liquid form on the plant or plant debris. Particularly preferred are modes of application in which the composition or the components of the kit are applied to the ears of the plant (provided the plant has ears, such as in the case of wheat and maize) or by application of the composition or the components of the kit on the leaf of the plant. In embodiments where the composition or the components of the kit are applied to the leaf of the plant (such as in the case of wheat and maize), it is preferred if the composition or the components of the kit are applied to the plant before appearance of the ears, e.g. two to three days in advance.

Furthermore, the method of the present invention also encompasses application of the composition or the components of the kit to plant debris (i.e. dead plant material). This will typically be done after harvest and on the plant debris remaining in the field. Typically, this will occur prior to the next growing season. The next growing season need not necessarily rely on the same plant. For example, the plant debris could be plant debris of maize and the next growing season could relate to growing wheat on the same (or on an adjacent) field.

Where the method of the present invention involves a composition (or kit) comprising calcium chloride, the composition (or the calcium component of the kit) is preferably applied to the field on which the plant is growing (or the plant debris is located) in an about 5 mM to about 250 mM, more preferably about 30 mM to about 100 mM. For example, in those embodiments where calcium is provided in the form of calcium chloride, the composition (or kit) may comprise about 0.3% to 3% for calcium chloride. The most preferred concentration range may vary slightly with the plant to be treated.

### EXAMPLES

In the following, specific examples illustrating various embodiments and aspects of the invention are presented. However, the present invention shall not to be limited in scope by the specific embodiments described herein. Indeed, various modifications of the invention in addition to those described herein will become readily apparent to those skilled in the art from the foregoing description, accompanying figure and the examples below. All such modifications fall within the scope of the appended claims.

TABLE 1
Overview of components used

| Components used | Chemical/Microorganisms |
|---|---|
| Component A | Calcium chloride |
| Component B | Lactiplantibacillus plantarum subsp. plantarum (formerly known as |
| | Lactobacillus plantarum), Lacticaseibacillus casei (formerly known as |
| | Lactobacillus casei), Limosilactobacillus fermentum (formerly known |
| | as Lactobacillus fermentum), Saccharomyces cerevisiae |
| Component C | Lactiplantibacillus plantarum subsp. plantarum (formerly known as |
| | Lactobacillus plantarum), Lacticaseibacillus casei (formerly known as |
| | Lactobacillus casei), Limosilactobacillus fermentum (formerly known |
| | as Lactobacillus fermentum), Saccharomyces cerevisiae, |
| | Bifidobacterium bifidum, Bifidobacterium animalis, |
| | Rhodopseudomonas palustris |
| Component D | Calcium carbonate from natural resources |
| Component E | Propionic acid, 99% |
| Component F | Magnesium chloride |
| Component G | Sodium silicium oxide |

### Example 1: Effect of Microorganisms and Calcium on Living Cereal Plants (Wheat)

1.1 Small Scale Field Experiment Season 1

Two winter wheat varieties (“Lennox” and “Capo”) and 2 spring wheat varieties (“Trappe” and “Kronjet”) were sown in 1 m² plots (96 plots/variety). Experimental design in the first small scale field season were completely randomized blocks with 3 replications, respectively. In these experiments the complete plot (1 m²) was treated with the variants of interest.

A particular technique for artificial inoculation to mimic the natural Fusarium infection process as closely as possible was used: the so-called kernel-spawn method F. graminearum colonized maize kernels were distributed on the soil surface between the wheat plants about 3 weeks before anthesis (ca. 15 gr/m²). On the kernels perithecia are produced which eject the ascospores in the air. These spores infected the wheat ears, leading to a constant infection pressure over a longer period of time and thus mimicking closely a natural infection process. To support infection, the complete experiment was mist-irrigated to provide sufficient humidity for disease initiation.

Table 2 summarizes all prototypes used in Example 1.1. Experiment variant W1 contains microbial species (see Table 1). Variants W2-W4 deal with the cations Ca²⁺, Mg²⁺ and Si²⁺. They were applied on the ear only. The inventors deliberately choose a high concentration of the cations to make sure to see effects (if present), however not too high in order to prevent phytotoxic reactions caused by excessive cation concentrations.

TABLE 2
Summary of the set-up of the first small scale field experiment

| | Microbial | | Calcium | | Other | | |
|---|---|---|---|---|---|---|---|
| Prototype | Component | Concentration | Component | Concentration | Components | Concentration | |
| Control | — | — | — | — | — | — | |
| W1 | Component C | 5 l/ha | | | — | | |
| W2 | — | | Component A | 3% | — | | |
| W3 | — | | — | | Component | 10 | kg/ha |
| | | | | | F | | |
| W4 | — | | — | | Component | 10 | kg/ha |
| | | | | | G | | |
| PPP | | | | | Folicur | 1.5 | l/ha |

After about 50% heading of wheat ears and short before flowering (about 2-3 days) the ears were treated. In this case the test substances can act via induction of SIR. But also direct interaction with the plant pathogen is possible due to physical contact with the test organisms/calcium. Other mechanisms of antagonism can be tested in this way, including direct inhibition of the pathogen or competition for nutrients. To this end a hand sprayer was used to apply 100 ml/plot of the suspension/solution. For each wheat genotype the inventors used 3 replications of each treatment and 10 control plots. All treatments were completely randomized within each wheat genotype. During the flowering period of the wheat varieties the experiment was mist irrigated every second day for about 20 hours with water pulses of 20 seconds repeated every 20 minutes to promote Fusarium infection. The inoculum is continuously produced in form of ascospores originating on perithecia which develop on the Fusarium (Gibberella zeae) colonized kernels distributed on the soils surface.

Table 3 represents data on reduction of FHB symptoms as assessed 21 days after anthesis. All main ears in the plot (from 96 to 225 ears) were evaluated for FHB symptoms and the percentage of diseased ears was calculated. Disease incidence (diseased ears) in the control was set at 100% and the data of the treatments are expressed as percentage of the untreated control. For example, for the fungicide treatment (PPP) “Folicur®” (active ingredient: Tebuconazole, Bayer Crop Science) the mean symptom level relative to the control over all genotypes was 32% (data not shown): this represents a reduction of the symptoms of 68% as compared to the control. ANOVA analyses were done with disease incidence data.

TABLE 3
Summary of the results of the first small scale field experiment.

| Genotype/ | Prototype | Tissue | Reduction of Symptoms |
|---|---|---|---|
| Variety | used | treated | (Disease incidence %) |
| Capo, Lennox, | Control | no treatment | — |
| Trappe, Kronjet | PPP | ear | 68*** |
| | W1 | ear | 23** |
| | W2 | ear | 29* |
| | W3 | ear | ns |
| | W4 | ear | ns |

***p ≤ 0.001(highly significant);
**p ≤ 0.01;
*p ≤ 0.05;
+, p ≤ 0.10;
ns, p > 0.10 (not significant)

Results are summarized as follows (see Table 3):
1) The fungicide Folicur® (PPP) showed the largest reduction in symptoms: a reduction of 68% as compared to the control treatment.
2) The microbial treatment variant W1 reduced symptoms by 23%
3) The calcium containing variant W2 led to a significant reduction of the FHB symptoms with 29%
4) Silicium and magnesium had no influence on FHB symptom reduction, even when applied at high concentrations.

1.2 Small Scale Field Experiment Season 2 In a second small scale field season, the most effective treatments of the first field experiment that included calcium and microbial components were again investigated, now in combination, along with new prototypes treatments listed in Table 4. Methods of testing and analysis were identical as described in the first experiment with following exceptions:

In the second season, only half of the plot (3 rows) was treated and the second half of the plot was not treated, functioning as a direct control for the prototypes under investigation (5 replications). Due to challenging weather conditions during ear emergence, only one variety, “Trappe”, could be finally assessed for FHB symptoms (Table 5)

TABLE 4
Summary of the set-up of the second field experiment.

| | Microbial | | Calcium | | Other | |
|---|---|---|---|---|---|---|
| Prototype | Component | Concentration | Component | Concentration | Components | Concentration |
| Control | — | — | — | — | — | — |
| W6 | Component B | 1 l/ha | Component A | 0.9% | — | |
| W12 | Lacticaseibacillus | 3 l/ha | — | | | |
| | casei 1 | | | | | |
| | (single strain) | | | | | |
| W13 | Limosilactobacillus | 3 l/ha | — | | | |
| | fermentum 1 | | | | | |
| | (single strain) | | | | | |
| W14 | Limosilactobacillus | 3 l/ha | — | | | |
| | fermentum 2 | | | | | |
| | (single strain) | | | | | |
| W15 | Limosilactobacillus | 3 l/ha | — | | | |
| | fermentum 3 | | | | | |
| | (single strain) | | | | | |
| W16 | Lactiplantibacillus | 3 l/ha | — | | | |
| | plantarum subsp. | | | | | |
| | plantarum 1 | | | | | |
| | (single strain) | | | | | |
| W17 | Lactiplantibacillus | 3 l/ha | — | | | |
| | plantarum subsp. | | | | | |
| | plantarum 2 | | | | | |
| | (single strain) | | | | | |
| W18 | Lactiplantibacillus | 3 l/ha | — | | | |
| | plantarum subsp. | | | | | |
| | plantarum 3 | | | | | |
| | (single strain) | | | | | |
| W19 | Lactiplantibacillus | 3 l/ha | — | | | |
| | plantarum subsp. | | | | | |
| | plantarum 4 | | | | | |
| | (single strain) | | | | | |
| W20 | Saccharomyces | 3 l/ha | — | | | |
| | cerevisiae 1 | | | | | |
| | (single strain) | | | | | |
| W21 | Saccharomyces | 3 l/ha | — | | | |
| | cerevisiae 2 | | | | | |
| | (single strain) | | | | | |
| W22 | Saccharomyces | 3 l/ha | — | | | |
| | cerevisiae 3 | | | | | |
| | (single strain) | | | | | |
| W23 | Saccharomyces | 3 l/ha | — | | | |
| | cerevisiae 4 | | | | | |
| | (single strain) | | | | | |
| W25 | — | | Component D | 3 kg/ha | | |
| PPP | | | | | Folicur ® | 1.5 l/ha |

In this experiment, a new composition with reduced number of microbial strains was used in combination with calcium (W6). Furthermore, single strains were analysed for potential effects on FHB reduction (W12-23)(see Table 4). On the one hand, all single strains that are part of microbial component B were screened. Furthermore, additional single strains from the same genus were purchased from public repositories were assessed for potential effects on symptom reduction in FHB. Finally, a further calcium variant, calcium carbonate (CaCO₃) from natural sources was also assayed for symptom reduction (W25).

TABLE 5
Summary of the results of the second field experiment.

| Genotype/ | Prototype | Tissue | Reduction of Symptoms |
|---|---|---|---|
| Variety | used | treated | (Disease incidence %) |
| Trappe | Control | no treatment | — |
| | PPP | ear | 56** |
| | W6 | ear | 28*** |
| | W12 | ear | ns |
| | W13 | ear | ns |
| | W14 | ear | ns |
| | W15 | ear | ns |
| | W16 | ear | ns |
| | W17 | ear | ns |
| | W18 | ear | ns |
| | W19 | ear | ns |
| | W20 | ear | ns |
| | W21 | ear | ns |
| | W22 | ear | ns |
| | W23 | ear | ns |
| | W25 | ear | 13* |

As a result, no significant reduction of symptoms could be observed when applying single microbial strains (W12-W23) (see Table 5). Calcium carbonate alone reduced FHB symptoms by 13%, while the combination of the microbial component B together with CaCl₂ reduced symptoms by 28%. Overall infection pressure was high in this field trial, since also the chemical PPP Folicur® reduced FHB symptoms by no more than 58%.

1.3 Greenhouse Experiment 1 Two wheat varieties (“Remus”, spring wheat, susceptible for Fusarium head blight (FHB), and “Capo”, winter wheat and medium resistant) were sown in pots (10 plants/pot filled with 7 L of substrate) in the greenhouse. The substrate was a mixture of compost, peat and sand. A mineral fertilizer was applied at tillering. For each treatment 4 pots were randomly selected and treated in an identical way. The 4 pots were regarded as a single entry and placed and evaluated together (as a quadratic unit consisting of 4 neighbouring pots) in the greenhouse. In the experiments 3 to 4 replications (units of four pots each) were used.

Spore suspensions of the plant pathogen F. graminearum were produced in mung bean broth with the bubble breeding method and small aliquots were frozen at −80° C. until use. Final spore suspensions contained either 20.000 (low concentration to be used on “Remus”) or 50.000 (high concentration for application on “Capo”) Fusarium macroconidia/mL.

In order to be able to treat the ears, the amount of the product required for the area (0.038 m²/pot) was suspended in the 20 mL water. The test organisms/cations were applied by spraying the suspension on the ears after heading but at least 2-3 days before flowering. Also part of the leaf canopy was wetted (especially flag leaf). This was done for each pot individually. With this strategy, a combination of several mechanisms of antagonists can be tested including induction of systemic induced resistance (SIR) but also direct antagonism such as competition for nutrients as well as direct inhibition of the pathogen (calcium).

At flowering the ears in each pot were treated with a Fusarium spore suspension. To this end, 20 mL of the spore suspension in low or high concentration was applied with a hand sprayer on the flowering ears in each pot. Subsequently the ears were covered with a plastic bag for 24 or 48 hours to ensure sufficient humidity for infection. During the experiment temperature in the greenhouse was 18/20° C. (night/day) and the plants were daily illuminated for 16 hours.

TABLE 6
Summary of the set-up of the first greenhouse experiment

| | Microbial | | | | | Other |
|---|---|---|---|---|---|---|
| Prototype | Component | Concentration | Calcium Component | Concentration | | Components |
| Control | — | — | — | — | | — |
| W5 | Component | 1 l/ha | Component A | 1.5% | | — |
| | B | | | | | |
| W6 | Component | 1 l/ha | Component A | 0.9% | | — |
| | B | | | | | |
| W7 | Component | 1 l/ha | Component D, 25 gr + | 5 | l/ha | — |
| | B | | Component E 57 ml ad 1 l | | | |
| W8 | Component | 1 l/ha | Component D, 25 gr + | 10 | l/ha | — |

| | |
|---|---|
| B | Component E 57 ml ad 1 l |

In the first greenhouse experiment, the combination of microbial component B and CaCl₂ were tested at different CaCl₂ concentrations (W5-6) (see Table 6). Furthermore, additional calcium variants were tested, which included CaCO₃ in a mixture with propionic acid, yielding calcium propionate from natural sources (W7-8). The experiment further included an untreated control for reference.

At 7, 11, 15 and 18/19 days after inoculation the 2 disease parameters were assessed: Disease Incidence (% diseased ears) and Disease Severity (% diseased spikelets of the diseased ears only). Thereafter Disease Intensity (% of diseased spikelets over all ears) was calculated. In the end, the % reduction of symptoms was calculated for each disease parameter (compared to the control treatment). ANOVA analyses were performed for statistical analysis.

TABLE 7
Summary of results of the first greenhouse experiment

| | | Reduction of Symptoms (%) | | |
|---|---|---|---|---|
| Genotype/ | Prototype | Disease | Disease | Disease |
| Variety | used | incidence % | severity % | intensity % |
| Remus | Control | — | — | — |
| | W5 | 33.9* | 18.2ns | 45.7** |
| | W6 | 61.6** | 30.5* | 72.4*** |
| | W7 | ns | ns | 32.7* |
| | W8 | ns | ns | ns |

As a result, only one of the calcium propionate-containing prototypes (W8) in combination with component B had no statistically significant effect on symptom reduction of FHB. All other prototypes led to reduction of disease intensity. Overall, the variants including calcium chloride (W5-6), performed better in reduction of disease symptoms. However, a reduction of CaCl₂ input from 5 l/ha to 3 l/ha as shown with prototype W6, led to an even improved outcome and reduced disease intensity by 72.4% as compared to W5 with a reduction of 45.7%.

1.4 Green House Experiment 2

This experiment was performed and evaluated in the same way as the first greenhouse experiment (see 1.3) with the exemption that in this experiment, two spring wheat varieties, Capo and Remus, were included.

TABLE 8
Summary of the set-up of the second greenhouse experiment

| | Microbial | | Calcium | | | Other | |
|---|---|---|---|---|---|---|---|
| Prototype | Component | Concentration | Component | Concentration | | Components | Concentration |
| Control | — | — | — | — | | — | — |
| W6 | Component | 1 l/ha | Component A | 0.9% | | — | |
| | B | | | | | | |
| W9 | Component | 1 l/ha | Component D | 3 | kg/ha | — | |
| | B | | (CaCO3) | | | | |
| W10 | Component | 1 l/ha | Component D, | 7.5 | l/ha | — | |
| | B | | 120 gr + | | | | |
| | | | Component E | | | | |
| | | | 220 ml ad 1l | | | | |
| W11 | Component | 1 l/ha | Component D, | 5 | l/ha | — | |
| | B | | 120 gr + | | | | |

| | | | |
|---|---|---|---|
| | Component E | | |
| | 220 ml ad 1l | | |
| PPP | | Folicur ® | 1.5 l/ha |

In this experiment, microbial component B was again combined with different calcium variants including CaCl₂ (W6), CaCO₃ (W9) or calcium propionate (W10-11) as wells to the fungicide Folicur (see Table 8).

TABLE 9
Summary of results of the second greenhouse experiment

| | | Reduction of Symptoms (%) | | |
|---|---|---|---|---|
| Genotype/ | Prototype | Disease | Disease | Disease |
| Variety | used | incidence % | severity % | intensity % |
| Remus, | Control | — | — | — |
| Capo | PPP | 55.3* | 61.5** | 82.4** |
| | W6 | 26.9* | 17.6* | 39.7* |
| | W9 | ns | ns | 26.5* |
| | W10 | 9.3+ | ns | 21* |
| | W11 | ns | ns | ns |

Similarly, as in the first greenhouse experiment, the combination of microbial component B with different calcium variants showed effects (see Table 9), with CaCl₂ yielding highest reduction (W6, 39.7%), CaCO₃ alone (W9) a lesser pronounced reduction of 26.5% and CaCO₃ plus propionic acid (W10) either a mild reduction of 21% (W10) or no significant reduction (W11). The fungicide Folicur reduced symptoms by 82.4%.

1.5 Green House Experiment 3

The third greenhouse experiment was essentially performed and evaluated in the same way as the first greenhouse experiment (see 1.3) with the exemption that in this experiment the winter wheat variety Capo was used only.

TABLE 10
Summary of the set-up of the third greenhouse experiment

| | Microbial | | Calcium | | | Other | |
|---|---|---|---|---|---|---|---|
| Prototype | Component | Concentration | Component | Concentration | | Components | Concentration |
| Control | — | — | — | — | | — | — |
| W6 | Component B | 1 l/ha | Component A | 0.9% | | — | |
| W9 | Component B | 1 l/ha | Component D | 3 | kg/ha | — | |
| W10 | Component B | 1 l/ha | Component D, | 7.5 | l/ha | — | |
| | | | 120 gr + | | | | |
| | | | Component E | | | | |
| | | | 220 ml ad 1l | | | | |
| W24 | — | | Component D | 1.5 | kg/ha | | |

| | | |
|---|---|---|
| PPP | Folicur ® | 1.5 l/ha |

In the second greenhouse experiment, microbial component B was again combined with different calcium variants including CaCl₂ (W6), CaCO₃ (W9, W24) or calcium propionate (W10) as wells to the fungicide Folicur (see Table 10).

TABLE 11
Summary of results of the third greenhouse experiment

| | | Reduction of Symptoms (%) | | |
|---|---|---|---|---|
| Genotype/ | Prototype | Disease | Disease | Disease |
| Variety | used | incidence % | severity % | intensity % |
| Capo | Control | — | — | — |
| | PPP | 29.2+ | ns | 54.6* |
| | W6 | 25.7+ | 26.3+ | 47.9* |
| | W9 | ns | 22.5+ | ns |
| | W10 | ns | 21.8+ | 27.6+ |
| | W24 | ns | ns | ns |

Similarly, as in the first and second greenhouse experiment, the combination of microbial component B with different calcium variants showed effects, with CaCl₂ yielding highest reduction of disease intensity (W6, 47.9%), reaching almost the level of PPP (54,6) (see Table 11). In this experiment, CaCO₃ alone (W9) only reduced disease severity significantly, but not overall intensity, a lower concentration of CaCO₃ alone had no significant effect (W24). CaCO₃ plus propionic acid (W10) again showed reduction of disease intensity by 27.6%.

1.6 Large Scale Field Experiment Season 1

The goal of these experiments was to test promising components under real practical conditions. This means that the farmers applied the prototypes with their own equipment. The farms were located in the 3 important climatic regions in Austria: The North-Alpine region (wet and warm), the Pannonicum (dry and hot) and the Illyricum (wet and hot). This approach gives a good overview of the effectiveness of the prototype under different environmental conditions. The fields selected for the tests were normal fields used for farming. Previous crop was maize in all cases, which leads to a higher probability of Fusarium infection in wheat in the following season.

Well-repeated experiments with proper statistical design came to use. This included replications (typically 3 to 4) and care was taken to have respective controls (=no treatment) in vicinity of the treated variants (Prototype W6). The prototype was applied at the prescribed concentration (in L/ha) on the ears at 50% heading or shortly thereafter, but not later than 2-3 days before flowering. Fusarium infection occurred under natural conditions, hence no artificial infection using Fusarium spores was done. Infection pressure varied between locations according to the different climatic condition during flowering, ranging from low to high overall Fusarium infection rates.

Two to three weeks after flowering FHB disease was assessed. To this end up to 500 ears for each entry were visually evaluated for typical FHB symptoms including water-soaked spots and spreading of the disease (wilted spikelets or ear segments). Each ear was classified being diseased or healthy and the Disease Incidence (DI=percentage of diseased ears) was calculated. The percentage of reduction of symptoms was calculated (in comparison to the control).

TABLE 12
Summary of results from large scale field trials

| | Prototype | Tissue | Reduction of |
|---|---|---|---|
| Location | treated | treated | Symptoms (in %) |
| Location 1 (low | Control | no treatment | — |
| infection pressure) | W6 | ear | 49.7* |
| | Control | no treatment | — |
| Location 2 (low- | W6 | ear | 45.7* |
| medium infection pressure) | | | |
| Location 3 (high | Control | no treatment | — |
| infection pressure) | W6 | ear | 22.8** |

The results (see Table 12) show that, compared to the untreated control, the combination of microbial and calcium containing components as used in Prototype W6 lead to reduction of FHB symptoms in all locations. Depending on the climatic conditions and infection pressure in the field, the FHB symptoms were reduced by 49.7% and 45.7%, respectively in locations with low to medium infection pressure. At high Fusarium infection pressure, still a reduction of 22.8% of FHB symptoms could be observed. Overall, the results obtained with prototype W6 corresponded reasonably well over all different test systems and genotypes used, from the greenhouse to the large-scale field.

1.7 Large Scale Field Experiment Season 2

In a second large scale field season, the treatments of the first field experiment that included calcium and microbial components were again investigated. Methods of testing and analysis were identical as described in the first experiment with following exceptions:
Only one site in Upper-Austria was included in the analysis, due to heavy droughts in other parts of the country where no infection with Fusarium could be observed.
This time, the trial included 2 treatment variants: (1) a single treatment as described in 1.6 and (2) a dual treatment at emergence of the flag leaf (around BBCH 37-39) and at 50% ear emergence (around BBCH 55) or shortly thereafter.
To this end 250 ears for each entry were visually evaluated for typical FHB symptoms including water-soaked spots and spreading of the disease (wilted spikelets or ear segments).

TABLE 13
Summary of the set-up and results of the
large scale field experiment in season 2

| | Prototype | Tissue | Reduction of |
|---|---|---|---|
| Location | treated | treated | Symptoms (in %) |
| Location with high | Control | no treatment | — |
| infection pressure | W6 - single | ear | 30.6+ |
| | W6 - double | Flag leaf, ear | 68.0*** |

In the second season, the results of the large-scale field trial are summarized in table 13 and show again a reduction of symptoms of around 30% even at high infection pressure with a single application of prototype W6. A dual application of prototype W6 lead to a highly significant reduction of symptoms of 68%. Again, these data are consistent with what could be observed in prior trials and under different testing conditions.

### Example 2: Effect of Microorganisms and Calcium on Perithecia Production on Crop Debris

Reduction of primary inoculum of the fungus is one of the most important strategies in control of Fusarium head blight disease. F. graminearum survives saprophytically on crop residues during the winter. Ascospores (sexual spores) of Gibberella zeae (=perfect form of F. graminearum) which are formed within asci in the fungal fruiting bodies (perithecium) serve as the primary inoculum in spring. Ascospores are forcibly discharged from the perithecium, land on susceptible parts of the plant and start infection. Therefore, inhibition of perithecia production on the Fusarium contaminated crop debris of cereals and maize crops of the past season results in reduced infection of the new crops.

Therefore, the inventors aimed at identifying means to inhibit perithecial production on crop debris.

For the field experiment, maize stalks were first cut into 7 cm long pieces and then each piece was longitudinally cut in half. The halves of three stalk pieces were placed in a 10 cm autoclavable plastic mesh bag and the corresponding half of the same pieces were placed in a separate bag labelled in a way to easily recognize the two corresponding halves of the same stem piece for experiment evaluation. One bag was used for antagonist treatment and the other one served as control. 12 bags containing a total number of 36 stalk pieces (36 replications) was used for each treatment or control. The pieces in the bags were immersed in distilled water overnight, and after decanting the water, placed in aluminium trays and subsequently autoclaved. The bags were then immersed for 3 min in a conidial suspension (3×10⁴ spores/ml) of a strong perithecia producing G. zeae strain. The inoculated pieces were incubated at 22° C. in darkness for 48 h.

TABLE 14
Summary of variants assayed in the perithecia assay on maize stalks

| | Microbial | Concentration | Calcium | Concentration | Other | Concentration |
|---|---|---|---|---|---|---|
| Control | — | — | — | — | — | — |
| Prototype M1 | — | | Component A | 33% | | |
| Prototype M2 | Component B | undiluted | — | | | |
| PPP | | | | | Folicur ® | 1.5 l/ha |

For treatment, one of the two corresponding bags was sprayed with the respective prototype variants (see Table 14) until runoff and the second bag was only sprayed with sterile distilled water. The bags were left overnight in the laboratory at room temperature (RT) and were next day transferred to the wheat or maize field and placed randomly on the soil surface between the wheat or maize plants. After 3-4 weeks, the bags were evaluated and the number of perithecia in a total area of 1 cm 2 of the maize stalk surface was counted.

The percentage of perithecia reduction in treatments was then calculated by comparison with the control. ANOVA analyses were performed for statistical analysis.

TABLE 15
Results perithecia assay on maize stalks

| Prototype | Tissue | Reduction of |
|---|---|---|
| used | treated | Perithecia (%) |
| Control | maize stalks | — |
| Chemical PPP | maize stalks | 48.74*** |
| M1 | maize stalks | 69.79*** |
| M2 | maize stalks | 60.09** |

As a result, M1 containing calcium reduced the perithecia numbers on the maize stalks in the field about 70% and the microbial composition M2 inhibited the perithecia formation by 60% (see Table 15). The commercial chemical fungicide PPP reduced the perithecia numbers only about 49%.

### Example 3: Effect of Microorganisms and Calcium on Other Diseases in Agricultural Crops

3.1 Downey Mildew in Grapevine

The inventors also observed that the microorganisms and calcium, alone or in combination, reduced disease pressure of other diseases on other crops. Respective results were obtained for downey mildew (Plasmopara viticola, “Peronospora”) and powdery mildew (Erysiphe necator; “Oidium”) on grapevines and Fusarium oxysporum in onions.

Exemplary tests for reduction of Peronospora symptoms were carried out on grapevine leaf discs as follows. Ten leaf discs were first inoculated with prototypes for 20 min and then treated with a spore suspension (20000 sporangia/ml) of the fungus until zoospores were released from the sporangia. Afterwards, leaf disks were placed on water agar plates and incubated for 5 days at 23° C. (16 h light/8 h darkness). Consequently, disease severity was calculated by measurement of the percentage of diseased disk area. Control treatments were included by either using water or by application of the copper-based, commercially available plant protection product Cuprozin.

TABLE 16
Summary of variants tested in grapevine leaf disc assay.

| Prototypes | Microbial | Concentration | Calcium | Concentration | Other | Concentration |
|---|---|---|---|---|---|---|
| G1 | — | | Component A | 2% | | |
| G2 | Component B | 1% | | | | |
| G3 | Component B | 1% | Component A | 2% | | |
| PPP | | | | | Cuprozine | 0.30% |

TABLE 17
Summary of the effect of different treatments on Peronospora
in grapevine described by disease severity.

| Prototype | Tissue | Reduction of Symptoms |
|---|---|---|
| used | treated | (Disease Severity %) |
| Control | Leaf disc | — |
| PPP | Leaf disc | 100*** |
| G1 | leaf | 50.9** |
| G2 | leaf | 7.3ns |
| G3 | leaf | 68.3*** |

These data demonstrate that the composition of microorganisms as well as calcium ions are effective against a variety of plant diseases and pathogens and that this effect is stronger and more significant when applied in combination (see Table 17).

3.2 Leaf Spot Diseases in Sugarbeet

Cercospora beticola and Ramularia betae are the causal fungi for leaf spot disease in sugar beet. Exemplary tests for control of leaf spot disease in sugar beet were carried out in the region of Lower Austria under real practical conditions. This means that the farmers applied the prototypes with their own equipment. The fields selected for the tests were normal fields used for farming.

Two adjacent rows were either treated with prototype W6 with the exemption, that the concentration of component A was lowered to 2 l/ha. A total of 4-5 treatments with W6 was carried out over the course of the season, starting around BBCH39 with the last application around BBCH 85. The second row was treated with a conventional plant protection plan using 3-5 treatments of commercial fungicides.

Natural infection occurred over the course of the field season, but especially in August and early September due to heavy rain falls.

Evaluation and rating of symptoms was based on the scaling procedure suggested by EPPO guideline PP1-4—foliar diseases of sugar beet. 20 plants per treatment that were located in vicinity to each other were evaluated. Only middle-aged leafs were considered for evaluation, between 7-15 leafs per plant were rated for symptoms. Disease incidence per treatment was calculated as the weighted mean of the over the scored plants in %.

TABLE 18
Summary of the effect of two different treatments
on leaf spot disease in sugar beet

| Score | Fungicide | Prototype W6 |
|---|---|---|
| 0.1% | 8 | 1 |
| 1% | 7 | 5 |
| 2% | 3 | 5 |
| 5% | 2 | 6 |
| 10% | 0 | 3 |
| 25% | 0 | 0 |
| 35% | 0 | 0 |
| 45% | 0 | 0 |
| 60% | 0 | 0 |
| >60% | 0 | 0 |
| Average disease | 1.19 | 3.75 |
| incidence (%) | | |

The fungicide treated sugarbeets showed a very low level of infection with leaf spot causing fungi of 1.19%. Treatment with prototype W6 also resulted in a low level of infection of 3.75%, even though weather conditions during the field season were very favorably for fungal growth (Table 18).

1-11. (canceled)

12. A composition comprising at least two microorganisms and optionally calcium, wherein at least one of the microorganisms is a bacterium and at least one is S. cerevisiae, and wherein among the bacteria are lactobacillales, and wherein the composition does not comprise R. palustris.

13. A composition comprising at least the following bacteria: L. fermentum, L. casei, two different kinds of L. plantarum strains, and at least one S. cerevisiae strain, and optionally further comprising calcium.

14. The composition according to claim 12, wherein the composition comprises L. plantarum subsp. plantarum.

15. A method comprising the step of applying a composition or kit comprising:
a) at least two different microorganisms, wherein the microorganisms are selected from bacteria and yeast, wherein at least one of the microorganisms is a bacterium and at least one is S. cerevisiae, and wherein the bacteria are selected from the group consisting of lactobacillales, rhizobiales and bifidobacteriales and optionally
b) calcium, wherein the calcium is present in form of calcium chloride, calcium acetate, calcium citrate, calcium propionate, calcium carbonate, calcium lactate, in particular calcium chloride, calcium carbonate or calcium propionate,
to a living plant and/or plant debris.

16. The method according to claim 15, wherein the composition or the components of the kit are applied to the ear or leaf of the living plant, preferably to the leaf.

17. The method according to claim 15, wherein the composition or the components of the kit are applied to plant debris.

18. The method according to claim 15, wherein the composition or the kit comprises calcium chloride and wherein calcium chloride is applied to the field comprising the living plant or plant debris in the range of about 0.3% to 5% (w/v), preferably 0.3 to % 0.9% (w/v).

19. The method according to claim 15, wherein the plant is selected from the group of small grain cereals, maize and grapevine, potato, sugar beet, onion, apple, oilseed rape and sunflower.

20. The method of claim 19, wherein the plant is selected from the group consisting of wheat, barley, oat, rye, triticale, maize, grapevine, in particular wherein the plant is selected from the group consisting of wheat, maize and grapevine.

21. The method according to claim 15, wherein the composition or kit comprises a bacterium selected from the group consisting of L. fermentum, L. casei, and L. plantarum.

22. The method according to claim 15, wherein the at least two different microorganisms are selected from the following microorganisms: L. fermentum, L. casei, L. plantarum, S. cerevisiae, R. palustris; Bifidobacterium bifidum, and B. animalis, preferably from L. fermentum, L. casei, L. plantarum, and S. cerevisiae.

23. The method according to claim 15, wherein the method improves plant health, improves plant resistance to plant pathogens, prevents or reduces mycotoxin contamination of plant material, improve plant resistance to a plant disease caused by a plant pathogen, prevents perithecia formation of a plant pathogen on plant debris, protects a plant and/or stimulates a plant.

24. The method according to claim 15, wherein the method is used for improving plant resistance to a plant pathogen, for improving plant resistance to a plant disease caused by a plant pathogen, and/or for preventing perithecia formation of a plant pathogen on plant debris, and wherein the plant pathogen is selected from the group consisting of Fusarium graminearum, Plasmopara viticola, Erysiphe necator, Phytophthora infestans, Cercospora beticola, Ramularia betae, Venturia inaequalis, Podosphaera leucotricha, Fusarium oxysporum and Sclerotinia sclerotiorum.

25. The method according to claim 15, wherein the pathogen is Fusarium graminearum and wherein the plant is wheat or maize.

26. The method according to claim 15, wherein the composition or kit comprises L. plantarum subsp. plantarum.

27. The method of claim 23, wherein the plant disease comprises fusarium head blight, fusarium ear rot, downy mildew, powdery mildew, Potato late blight, Cercospora leaf spot, Ramularia leaf spot, apple scab, basal root rot and Sclerotinia stem or head rot; in particular fusarium head blight or fusarium ear rot.
